(19) United States
(12) Patent Application Publication
(10) Pub. No.: US 2011/0119602 A1
(43) Pub. Date: May 19, 2011

(54) WEB SERVER, WEB BROWSER AND WEB SYSTEM

(75) Inventor: Masaaki Isozu, Tokyo (JP)

(73) Assignee: Sony Corporation, Tokyo (JP)

(21) Appl. No.: 12/943,537

(22) Filed: Nov. 10, 2010

(30) Foreign Application Priority Data
Nov. 19, 2009 (JP) 2009-264116

(51) Int. Cl. G06F 3/048; G06F 15/16

(52) U.S. Cl. 715/760

(57) ABSTRACT

A Web browser includes an extraction unit that extracts a link destination displayed in a display area from among one or two or more link destinations contained in a page displayed in a display screen, a request creation unit that creates a request to acquire content of the link destination, and a transmission unit that transmits the request to a Web server, and the Web server includes a reception unit that receives the request, a content creation unit that creates content in accordance with the request received, and a cache unit that caches the content created by the content creation unit in a storage apparatus.

### BACKGROUND OF THE INVENTION

1. Field of the Invention

The present invention relates to a Web server, a Web browser, and a Web system.

2. Description of the Related Art

In recent years, Web technology used by high-performance servers on the Internet is increasingly used by household devices (CE devices). This results from improved performance of embedded devices for consumers or increased opportunities to use consumer devices via a network. However, it is difficult for a device having limited computing resources or memory resources like a CE device to use all technologies that have been used on the server side, and thus a method of causing the device with limited resources to function needs to be devised.

Incidentally, “cache technology” is widely used as an existing technology to make access to a Web server faster. FIG. 11 is an explanatory view illustrating cache technology of a general Web service. As shown in FIG. 11, “cache” includes various kinds of caches such as a query cache to store results read by a Web server from a database, a proxy cache to store pages created by a Web server, and an application cache to store pages once accessed by a Web browser.

When expanding a Web service by a CE device, it is difficult to provide a proxy server so that it is difficult for a cache on the browser side to deal with dynamic content that is frequently rewritten. Thus, it is necessary to include a proxy cache (page cache) inside a server or use a query cache to realize improvement in the speed by a cache.

Both the page cache and the query cache produce their effects on a Web server that may be accessed by many and unspecified persons. For example, even if a user accesses a page for the first time, a pattern of occurrence of cache hit can be considered because another user has accessed the page in advance. In Japanese Patent Application Laid-Open No. 2006-227671, responsiveness is improved by caching each partial page to reduce the processing load of a Web server.

### SUMMARY OF THE INVENTION

However, according to Japanese Patent Application Laid-Open No. 2006-227671, there is an issue that it is necessary for the user to access the page at least once and when accessing users are limited like a Web service of a CE device, the cache frequently does not function effectively. According to Japanese Patent Application Laid-Open No. 2000-311108, improvement in the speed to access a Web server is realized by caching pages read ahead by following page links in advance. However, according to Japanese Patent Application Laid-Open No. 2000-311108, pages are cached in the cache memory up to its capacity limits and thus, there is an issue that the cache frequently does not function effectively if memory resources are limited.

In view of the foregoing, it is desirable to provide a novel and improved Web server, Web browser, and Web system capable of efficiently using caches even if memory resources or access to a Web service is limited.

According to an embodiment of the present invention, there is provided a Web server including a reception unit that receives a request to acquire content of a link destination displayed in a display area from among one or two or more link destinations contained in a page displayed in a Web browser connected via a network, a content creation unit that creates content in accordance with the request received by the reception unit, and a cache unit that caches the content created by the content creation unit in a storage apparatus.

The Web server may further includes a determination unit that determines whether the request received by the reception unit is a dummy request to acquire content of a link destination not yet accessed. When the determination unit determines that the request is a dummy request, the content creation unit may create content in accordance with the dummy request.

When a command indicating the dummy request is attached to the request, the determination unit may determine that the request is the dummy request.

The cache unit may delete, of the content cached in the storage apparatus, the content in accordance with a parent-child relationship with link destinations of the content displayed in the Web browser.

The Web server may further includes a transmission unit that transmits, when the content corresponding to the request is cached in the storage apparatus by the cache unit, the cached content to the Web browser.

When the determination unit may determine that the request is not the dummy request, the content creation unit transmits the created content to the Web browser via the transmission unit.

When the determination unit determines that the request is not the dummy request, the content creation unit may transmit the content corresponding to the request and cached in the storage apparatus to the Web browser via the transmission unit.

According to another embodiment of the present invention, there is provided a Web browser including an extraction unit that extracts a link destination is played in a display area from among one or two or more link destinations contained in a page displayed in a display screen, a request creation unit that creates a request to acquire content of the link destination extracted by the extraction unit, and a transmission unit that transmits the request to a Web server via a network.

The request creation unit may attaches a command indicating a dummy request to acquire content of a link destination not yet accessed to the request.

The extraction unit may determine whether the link destination displayed in a display area is static content or dynamic content and extracts the link destination when the link destination is the dynamic content.

Content created by the Web server in accordance with the dummy request may be cached in a storage apparatus.

The request creation unit may create the request to acquire the content of the accessed link destination. Further, the Web browser may include a reception unit that receives the content in accordance with the request from the Web server.

The request creation unit may create the request to acquire the content of the accessed link destination, and when the content in accordance with the request is cached in the storage apparatus, the reception unit may receive the content cached in the storage apparatus.

According to another embodiment of the present invention, there is provided a Web system including a Web browser connected to a Web server via a network,

the Web browser including an extraction unit that extracts a link destination displayed in a display area from among one or two or more link destinations contained in a page displayed in a display screen, a request creation unit that creates a request to acquire content of the link destination extracted by the extraction unit, and a transmission unit that transmits the request to the Web server, the Web server including a reception unit that receives the request transmitted from the Web browser, a content creation unit that creates content in accordance with the request received by the reception unit, and a cache unit that caches the content created by the content creation unit in a storage apparatus.

According to another embodiment of the present invention, there is provided a program causing a computer to function as a Web server, the Web server including a reception unit that receives a request to acquire content of a link destination among one or two or more link destinations displayed in a display area of a Web browser connected via a network, a content creation unit that creates content corresponding to the request received by the reception unit, and a cache unit that caches the content created by the content creation unit in a storage apparatus.

According to another embodiment of the present invention, there is provided a program causing a computer to function as a Web browser, the Web browser including an extraction unit that extracts a link destination displayed in a display area from among one or two or more link destinations contained in a page displayed in a display screen, a request creation unit that creates a request to acquire content of the link destination extracted by the extraction unit, and a transmission unit that transmits the request to a Web server connected via a network.

According to the present invention, as described above, caches can efficiently be used even if memory resources or access to a Web service is limited.

### BRIEF DESCRIPTION OF THE DRAWINGS

FIG. 1 is an explanatory view providing an overview of a Web system according to an embodiment of the present invention;

FIG. 2 is a block diagram showing a hardware configuration of a Web browser according to the embodiment;

FIG. 3 is a block diagram showing function configurations of the Web browser and a Web server according to the embodiment;

FIG. 4 is an explanatory view illustrating links contained in a displayed page according to the embodiment;

FIG. 5 is an explanatory view illustrating a dummy request according to the embodiment;

FIG. 6 is an explanatory view exemplifying a link structure according to the embodiment;

FIG. 7 is a list of pages stored in a cache according to the embodiment;

FIG. 8 is a flowchart showing details of link extraction processing according to the embodiment;

FIG. 9 is a flowchart showing addition processing of a link to a request queue according to the embodiment;

FIG. 10 is a flowchart showing processing of the Web server that has received a request message according to the embodiment; and

FIG. 11 is an explanatory view illustrating cache technology of a general Web service.

### DETAILED DESCRIPTION OF THE EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

“Detailed Description of The Embodiment” will be described in the order shown below:

### [1] Purpose of the Present Embodiment

### [2] Overview of the Web System

### [3] Hardware Configuration of the Web Browser

### [4] Function Configurations of the Web Browser and Web Server

### [5] Details of Operation of the Web System

First, the purpose of the present embodiment will be described. In recent years, Web technology used by high-performance servers on the Internet is increasingly used by household devices (CE devices). This results from improved performance of embedded devices for consumers or increased opportunities to use consumer devices via a network. However, it is difficult for a device having limited computing resources or memory resources like a CE device to utilize all technologies that have been used on the server side so that a method of causing the device with limited resources to function needs to be devised.

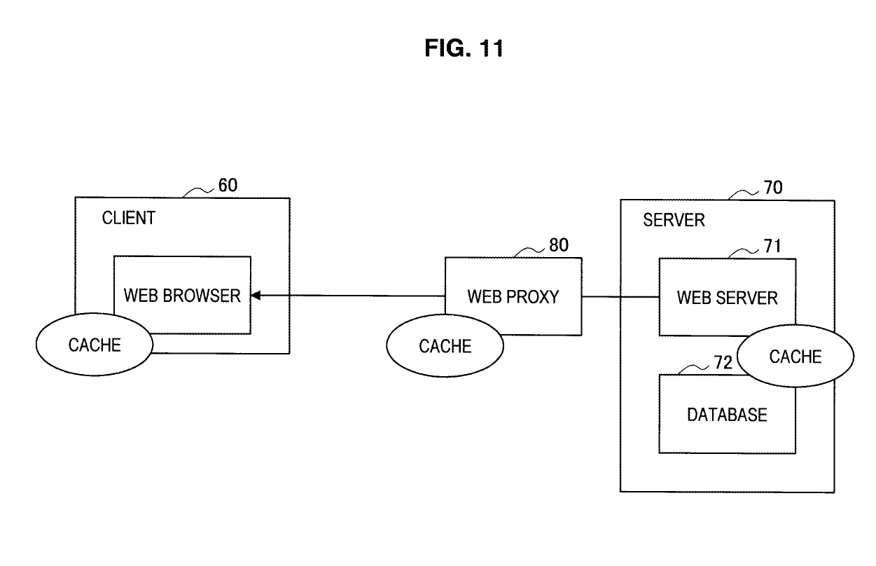

Incidentally, “cache technology” is widely used as an existing technology to make access to a Web server faster. FIG. 11 is an explanatory view illustrating cache technology of a general Web service. As shown in FIG. 11, “cache” includes various kinds of caches such as a query cache to store results read by a Web server from a database, a proxy cache to store pages created by a Web server, and an application cache to store pages once accessed by a Web browser.

When expanding a Web service by a CE device, it is difficult to provide a proxy server so that it is difficult for a cache on the browser side to deal with dynamic content that is frequently rewritten. Thus, it is necessary to include a proxy cache (page cache) inside a server or use a query cache to realize improvement in the speed by a cache.

Both the page cache and the query cache produce their effects on a Web server that may be accessed by many and unspecified persons. For example, even if a user accesses a page for the first time, a pattern of occurrence of cache hit can be considered because another user has accessed the page in advance. Moreover, a technology to improve responsiveness by caching each partial page to reduce the processing load of a Web server is disclosed.

However, according to the above technology, there is an issue that it is necessary for the user to access a page at least once and when accessing users are limited like a Web service of a CE device, the cache frequently does not function effectively. Thus, the above situation as a focus of attention led to the creation of a Web system 1 according to the present embodiment of the present invention. According to the Web system 1 in the present embodiment, caches can efficiently be used even if memory resources or access to a Web service is limited.

### [2] Overview of the Web System

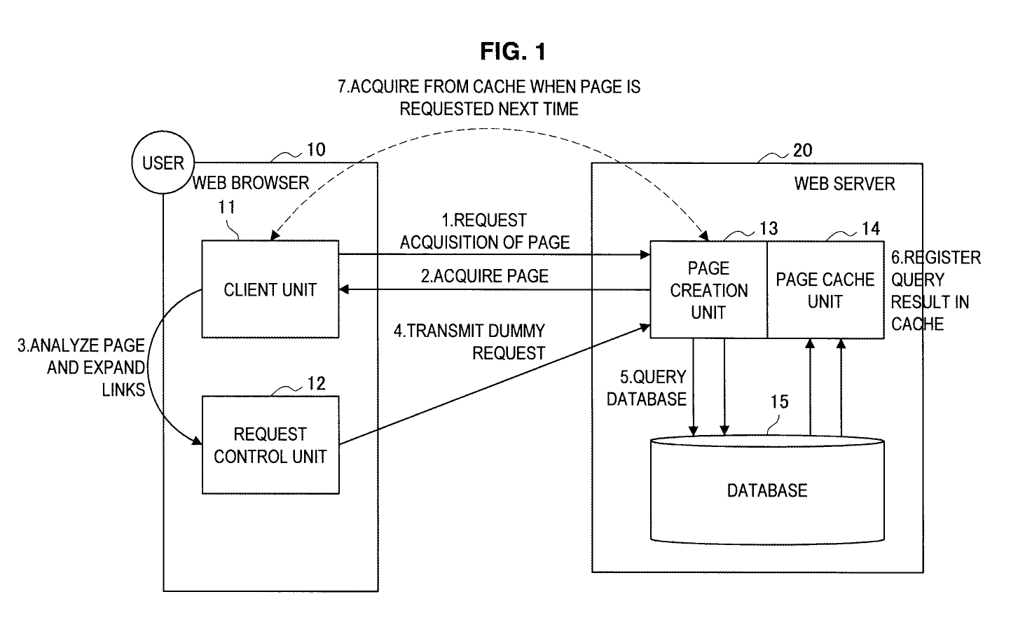

Next, an overview of the Web system 1 will be provided with reference to FIG. 1. FIG. 1 is an explanatory view providing an overview of the Web system 1. The Web system 1 includes a Web browser 10, a Web server 20 and the like. FIG. 1 illustrates a case where a user uses the Web browser 10 operating as a client device to browse pages of the Web server 20.

First, when the Web browser 10 accesses a desired address in accordance with a user's operation, the Web browser 10 issues a request to acquire an address destination page to the Web server 20. Then, the Web server 20 to which the request is transmitted from the Web browser 10 creates a page corresponding to the request while accessing a database necessary for the creation of the page. Then, the Web server 20 transmits the created page to the Web browser 10.

After acquiring the page transmitted from the Web server 20, the Web browser 10 renders the page in a display area. The Web browser 10 also analyzes links contained in the transmitted page. Then, the Web browser 10 determines whether link destination content is static content or dynamic content. If the link destination content is dynamic content, the Web browser 10 adds the request for the link destination content to a request queue.

The Web browser 10 attaches a command indicating a dummy request to the request added to the request queue and then transmits the dummy request to the Web server 20. The Web server 20 determines whether the transmitted request is a dummy request and, if the request is determined to be a dummy request, creates a page and stores the created page in a cache without transmitting the page to the Web browser 10.

If the request transmitted from the Web browser 10 is not a dummy request, the Web server 20 checks whether any page corresponding to the request is stored in the cache and, if such a page is stored, transmits the page to the Web browser 10. On the other hand, if no such page is stored, the Web server 20 creates a page and transmits the created page to the Web browser 10.

In the present embodiment, as described above, the Web browser 10 transmits not only a request for the address accessed by the user, but also a request to acquire content of a link destination displayed in the display area, among the link destinations on the displayed page, to the Web server 20. The Web browser 10 attaches a command indicating a dummy request to acquire link destination content not yet accessed to a link destination request displayed in the display area and not yet accessed. The Web server 20 determines whether the request transmitted from the Web browser 10 is a dummy request and, if the request is a dummy request, creates a page (content) corresponding to the request and immediately stores the created page in a cache. If, on the other hand, the request is not a dummy request, the Web server 20 creates a page corresponding to the request and transmits the created page to the Web browser 10.

Thus, pages can efficiently be cached even if memory resources are limited by looking ahead not only to link destination pages not yet accessed by the user, but also to only link destination pages displayed in the display area of the Web browser 10. Moreover, even if link destinations were less likely to be accessed due to access restrictions to Web services, by extracting link destinations displayed in the display area, link destinations more likely to be accessed can efficiently be cached.

### [3] Hardware Configuration of the Web Browser

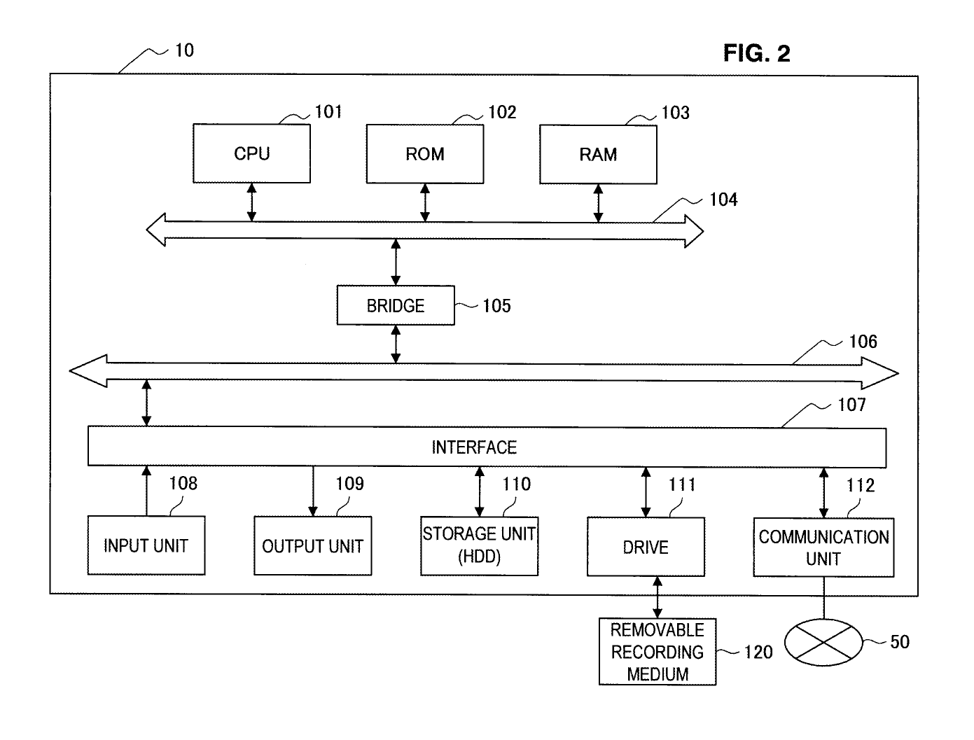

In the foregoing, an overview of the Web system 1 has been provided. Next, the hardware configuration of the Web browser 10 will be described with reference to FIG. 2. FIG. 2 illustrates the hardware configuration of the Web browser 10 and the hardware configuration of the Web server 20 is similar to that of the Web browser 10 and thus, a detailed description thereof is omitted.

FIG. 2 is a block diagram showing the hardware configuration of the Web browser 10. The Web browser 10 includes a CPU (Central Processing Unit) 101, a ROM (Read Only Memory) 102, a RAM (Random Access Memory) 103, a host bus 104, a bridge 105, an external bus 106, an interface 107, an input apparatus 108, an output apparatus 109, a storage apparatus (HDD) 110, a drive 111, and a communication apparatus 112.

The CPU 101 functions as an arithmetic processing apparatus and a control apparatus to control overall operations inside the Web browser 10 according to various programs. The CPU 101 may be a microprocessor. The ROM 102 stores programs, arithmetic parameters and the like used by the CPU 101. The RAM 103 temporarily stores programs used for execution by the CPU 101 and parameters that appropriately change during execution thereof. These units are mutually connected by the host bus 104 composed of a CPU bus or the like.

The host bus 104 is connected to the external bus 106 such as a PCI (Peripheral Component Interconnect/Interface) bus via the bridge 105. Incidentally, the host bus 104, the bridge 105, and the external bus 106 need not necessarily be constituted separately and these functions may be implemented by one bus.

The input apparatus 108 includes an input means for inputting information by a user such as a mouse, keyboard, touch panel, button, microphone, switch, and lever and an input control circuit that generates an input signal based on input by the user and outputs the input signal to the CPU 101. The user of the Web browser 10 can input various kinds of data into the Web browser 10 and issue instructions of processing operations by operating the input apparatus 108.

The output apparatus 109 includes, for example, a display apparatus such as a CRT (Cathode Ray Tube) display apparatus, liquid crystal display (LCD) apparatus, OLED (Organic Light Emitting Diode) apparatus, and lamp and a sound output apparatus such as a speaker and headphone. The output apparatus 109 outputs, for example, reproduced content. More specifically, the display apparatus displays various kinds of information such as reproduced video data as text or images. The sound output apparatus, on the other hand, converts reproduced sound data or the like into sound and outputs the sound.

The storage apparatus 110 is an apparatus for data storage and constituted as an example of the storage unit of the Web browser 10 according to the present embodiment and can include a storage medium, recording apparatus to record data in the storage medium, reading apparatus to read data from the storage medium, and deletion apparatus to delete data recorded in the storage medium. The storage apparatus 110 is constituted by, for example, an HDD (Hard Disk Drive). The storage apparatus 110 drives the hard disk to store programs executed by the CPU 101 or various kinds of data. Moreover, the storage apparatus 110 stores items and identification numbers described later.

The drive 111 is a reader/writer for storage medium and is built in or externally attached to the Web browser 10. The drive 111 reads information recorded in an inserted removable storage medium 24 such as a magnetic disk, optical disk, magneto-optical disk, and semiconductor memory and outputs the information to the RAM 103.

The communication apparatus 112 is a communication interface constituted by, for example, communication devices for connecting to a communication network 50. The communication apparatus 112 may be a wireless LAN (Local Area Network) compatible communication apparatus, wireless USB compatible communication apparatus, or wire communication apparatus that performs communication by wire.

### [4] Function Configurations of the Web Browser and Web Server

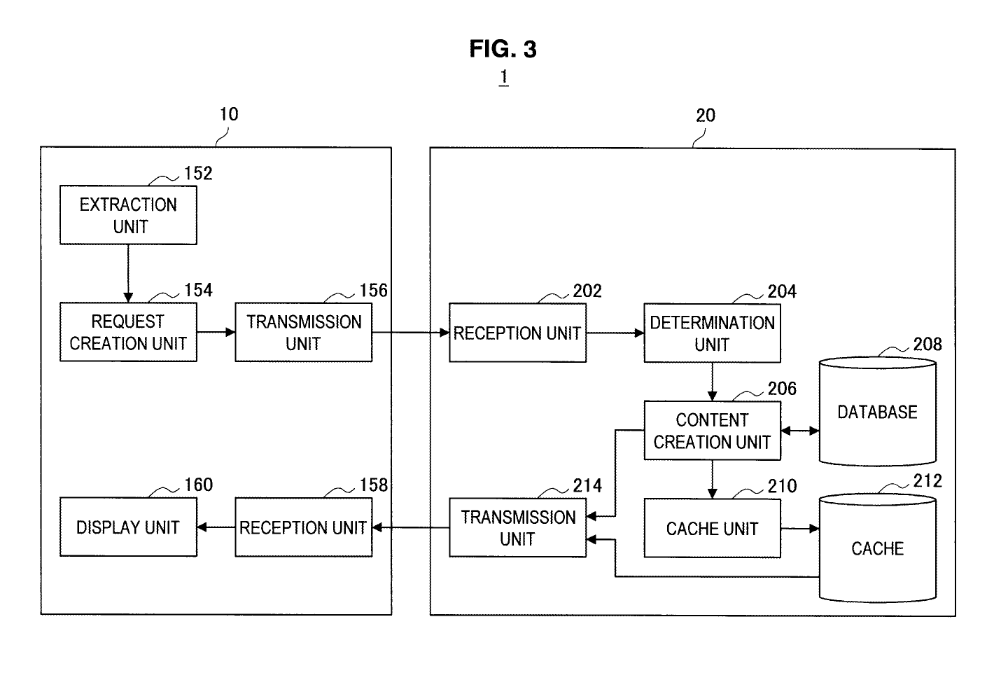

In the foregoing, the hardware configuration of the Web browser 10 has been described. Next, the function configurations of the Web browser 10 and the Web server 20 will be described with reference to FIG. 3. FIG. 3 is a block diagram showing the function configurations of the Web browser 10 and the Web server 20. As shown in FIG. 3, the Web browser 10 includes an extraction unit 152, a request creation unit 154, a transmission unit 156, a reception unit 158, and a display unit 160.

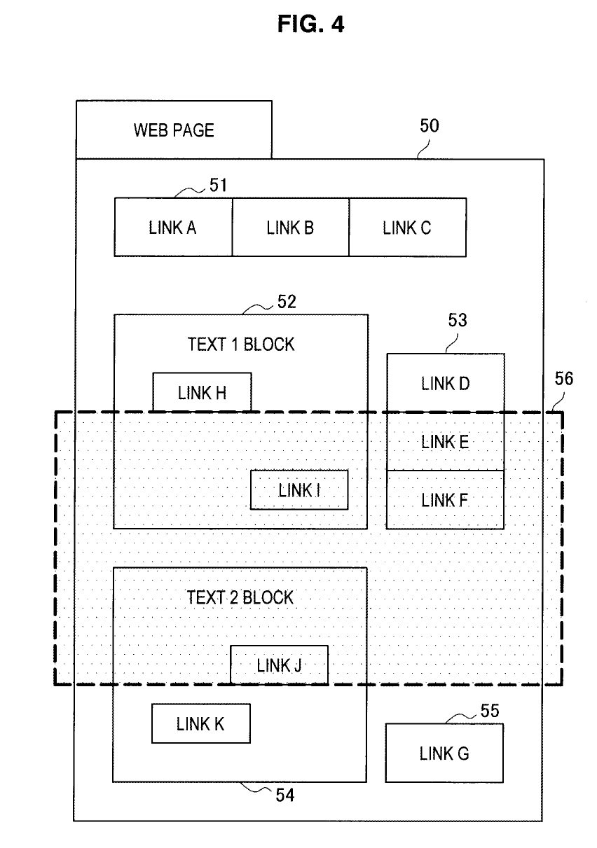

The extraction unit 152 has a function to extract link destinations contained in a page displayed in the display area of the Web browser 10. Here, link destinations contained in a displayed page will be described with reference to FIG. 4. FIG. 4 is an explanatory view illustrating links contained in a displayed page. As shown in FIG. 4, a page 50 rendered in the browser has a plurality of link destinations displayed therein. The extraction unit 152 does not extract all link destinations contained in the page 50, but extracts only link destinations visible on a display screen 56 of the browser.

Extracting only link destinations visible in the display screen 56 of the browser means to forecast link destinations the user is likely to click. This is because if a link destination is visible in the screen, the user is likely to click the link destination next. The extraction unit 152 extracts, for example, a link E, a link F, a link I, and a link J contained in the display screen 56 of the page 50. The extraction unit 152 may temporarily store information about extracted link destinations in a request queue (not shown). It is assumed, as described above, that links visible in the display screen are links likely to be clicked by the user, but the present invention is not limited to such an example and links likely to be clicked by the user may be forecast and extracted by considering a click history of the user.

The extraction unit 152 also determines whether an extracted link destination is static content or dynamic content and, if the extracted link destination is determined to be dynamic content, may store the link destination in the request queue. Whether a link destination is static content or dynamic content can be determined based on, for example, the extension of the link address. If the link destination is, for example, http://static.jp.sony.com.image.abc.png, the link destination can be determined to be static content because the link destination is a png file. Returning to FIG. 3, the extraction unit 152 provides information about the extracted link destination to the request creation unit 154.

The request creation unit 154 has a function to create a request to acquire content of the link destination extracted by the extraction unit 152. If, as described above, information about the extracted link destination is stored in the request queue, the request creation unit 154 creates a request of the link destination stored in the request queue. In this case, the request created by the request creation unit 154 is a dummy request to acquire content of a link destination not yet accessed by a user's operation.

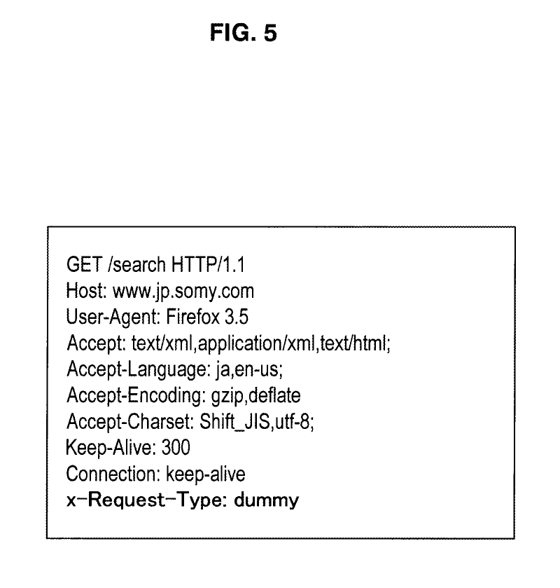

Here, a dummy request created by the request creation unit 154 will be described with reference to FIG. 5. As shown in FIG. 5, the request creation unit 154 inserts a dummy command “X-Request-Type: dummy” indicating that the request is a dummy request into the extended header of a general HTTP request. Returning to FIG. 3, the request creation unit 154 provides the created dummy request to the transmission unit 156. In the above example, a link contained in the displayed page is extracted and a dummy request is transmitted, but the present invention is not limited to such an example and all link destinations contained in the displayed page may be extracted to transmit a dummy request.

The transmission unit 156 has a function to transmit a dummy request provided from the request creation unit 154 to the Web server 20. The transmission unit 156 can transmit the dummy request by, for example, background processing of Java (registered trademark) Script, which is a function of HTML5. Alternatively, the browser may have a function that can perform background processing. If the request is a dummy request, the Web server 20 to which the dummy request has been transmitted from the transmission unit 156 of the Web browser 10 stores a created page in a cache without returning the page to the Web browser 10. Details of creating a page by the Web server 20 and storing the page in a cache will be described later.

The reception unit 158 has a function to receive a page created by the Web server 20 in response to a request that is not a dummy request or to receive a page stored in a cache. The reception unit 158 provides the received page to the display unit 160. The display unit 160 displays a page provided by the reception unit 158 on a display screen. The function configuration of the Web browser 10 has been described above.

Next, the function configuration of the Web server 20 will be described. The Web server 20 includes a reception unit 202, a determination unit 204, a content creation unit 206, a database 208, a cache unit 210, a cache 212, and a transmission unit 214. The reception unit 202 receives a request transmitted by the Web browser 10 to provide the request to the determination unit 204. Requests received by the reception unit 202 include requests of link destination pages accessed by users and dummy requests of link destination pages not yet accessed by users.

The determination unit 204 has a function to determine whether a request received by the reception unit 202 is a dummy request. A dummy request contains, as described above, a dummy command such as “X-Request-Type: dummy” and thus, the determination unit 204 determines that a request is a dummy request if a dummy command is contained therein.

The content creation unit 206 has a function to create a page corresponding to a request using information about various kinds of content stored in the database 208. If the determination unit 204 determines that a request is not a dummy request, the content creation unit 206 provides a created page to the transmission unit 214. If, on the other hand, the determination unit 204 determines that a request is a dummy request, the content creation unit 206 provides a created page to the cache unit 210.

The cache unit 210 has a function to cache content created by the content creation unit 206 in the cache 212. The cache 212 is an example of the storage apparatus of the present invention and a storage apparatus capable of reading/writing data at high speed. Here, a caching means to store content in a storage apparatus (the cache 212) capable of reading/writing data at high speed.

In the above description, a case where a whole page created by the content creation unit 206 is cached has been described, but the present invention is not limited to such an example. For example, if the content creation unit 206 issues a query to the database to dynamically assemble a page using a query result, only the query result may be cached in the cache 212.

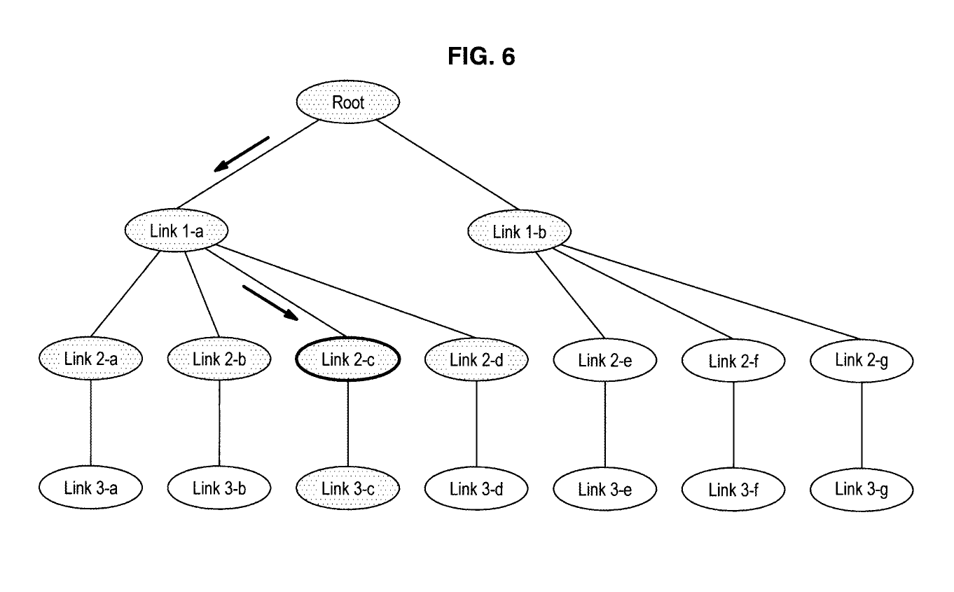

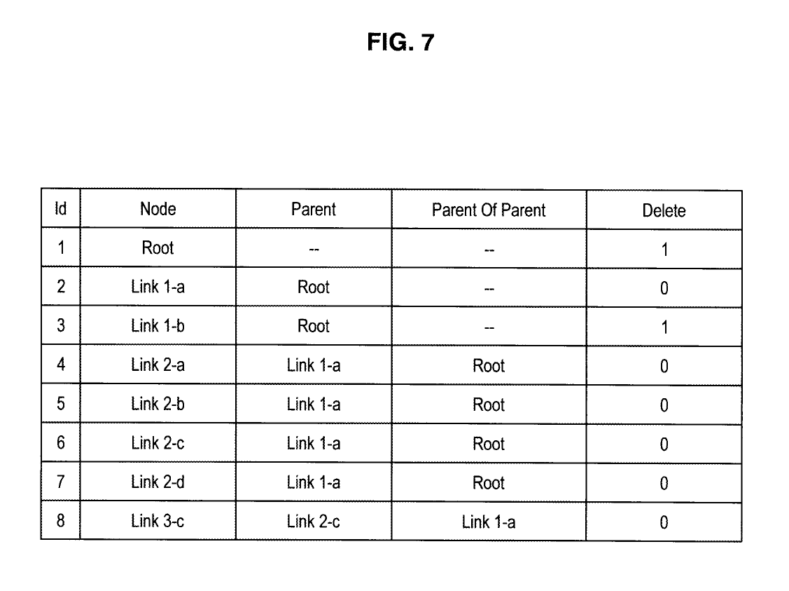

Since the cache 212 has cached therein many pages that are actually not accessed by the user, it is necessary to efficiently delete unnecessary pages if the Web server 20 is a device having insufficient memory resources. Thus, the cache unit 210 efficiently deletes cached pages taking relationships among cached pages into account. Here, efficient deletion of pages by the cache unit 210 will be described with reference to FIGS. 6 and 7.

FIG. 6 is an explanatory view exemplifying a link structure of some page. As shown in FIG. 6, it is assumed that Link2-c is reached from a Root page as a starting point via Link1-a. In the present embodiment, link destinations displayed in the display screen, that is, pages of shaded link destinations in FIG. 6 are stored in the cache.

Referring to the link structure in FIG. 6, the link destination likely to be clicked after Link2-c can be determined to be Link3-c. Moreover, Link3-c can be determined more likely to be clicked than Link1-b.

FIG. 7 is a list of pages stored in the cache 212 and corresponds to the link structure shown in FIG. 6. As shown in FIG. 7, the cache 212 associates a stored page with a parent page and also a parent page of the parent for storage. Thus, Link2-c is followed up from the Root page through Link1-a and therefore, pages that do not have Link1-a and Link2-c as parent pages can be determined less likely to be accessed.

Accordingly, the cache unit 210 can efficiently delete pages less likely to be accessed by deleting pages that do not have Link1-a and Link2-c as parent pages from the cache 212. In this case, Root and Link1-b become candidates for pages to be deleted and thus the cache unit 210 attaches a Delete flag to Root and Link1-b.

Alternatively, if determined that going back to previous pages is less likely, pages having Link2-c as a parent page may be left to delete all other pages. Alternatively, pages having Link2-c as a parent page may be deleted, but not if the parent page of the parent is the Root page. This is effective when the parent page of the parent is an important page like the Root page.

The transmission unit 214 has a function to transmit a page created by the content creation unit 206 or a page created and stored in the cache 212 to the Web browser 10. If a request transmitted from the Web browser 10 is not a dummy request, the transmission unit 214 transmits a page corresponding to the request to the Web browser 10.

In the above description, the database 208 and the cache 212 are assumed to be separate storage apparatuses, but the database 208 and the cache 212 may be the same storage apparatus. Also, the cache 212 is assumed to be included in the Web server 20, but the present invention is not limited to such an example and the cache 212 may be included in another apparatus. For example, the cache 212 may be included in the Web browser 10. In the foregoing, the function configuration of the Web server 20 has been described.

### [5] Details of Operation of the Web System

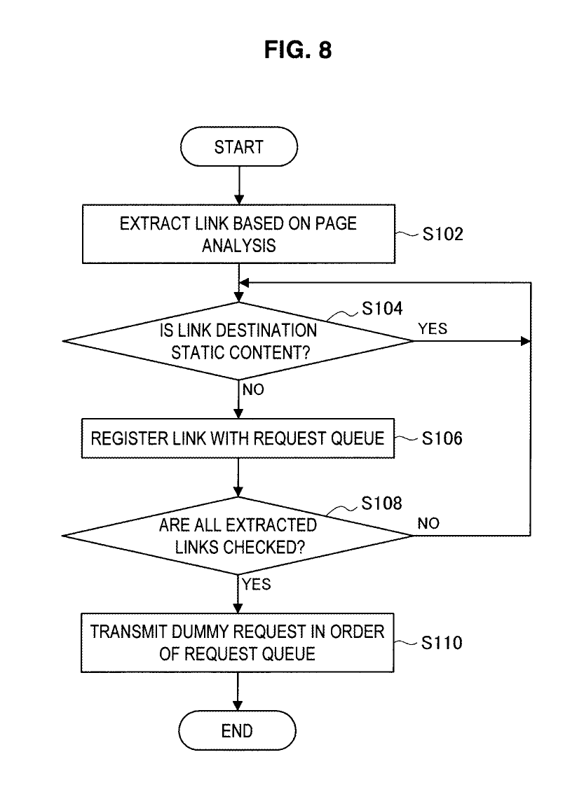

Next, the operation of the Web system 1 will be described in detail with reference to FIGS. 8 to 10. First, processing to extract links in a displayed page will be described with reference to FIG. 8. FIG. 8 is a flowchart showing details of link extraction processing by the Web browser 10. As shown in FIG. 8, first the extraction unit 152 of the Web browser 10 extracts a link in a page displayed in the display area (S102). Then, the extraction unit 152 determines whether the link destination extracted in step S102 is static content (S104).

If the link destination is static content in step S104, the extraction unit 152 performs the processing in step S104 for other links extracted in step S102. If a link destination is not static content in step S104, that is, the link destination is dynamic content, the extraction unit 152 registers the link with the request queue (S106). Then, the extraction unit 152 determines whether or not static content is checked for all links extracted in step S102 (S108).

If static content or dynamic content has been checked for all extracted links in step S108, processing in step S110 is performed. If, on the other hand, static content or dynamic content has not been checked for all extracted links in step S108, the extraction unit 152 repeats the processing in step S104 to step S108. Then, if all links extracted in step S108 have been checked, the transmission unit 156 transmits dummy requests to the Web server regarding links registered with the request queue in step S106. When transmitting a dummy request in step S110, as described above, the dummy request can be transmitted by background processing of Java Script (registered trademark), which is a function of HTML5.

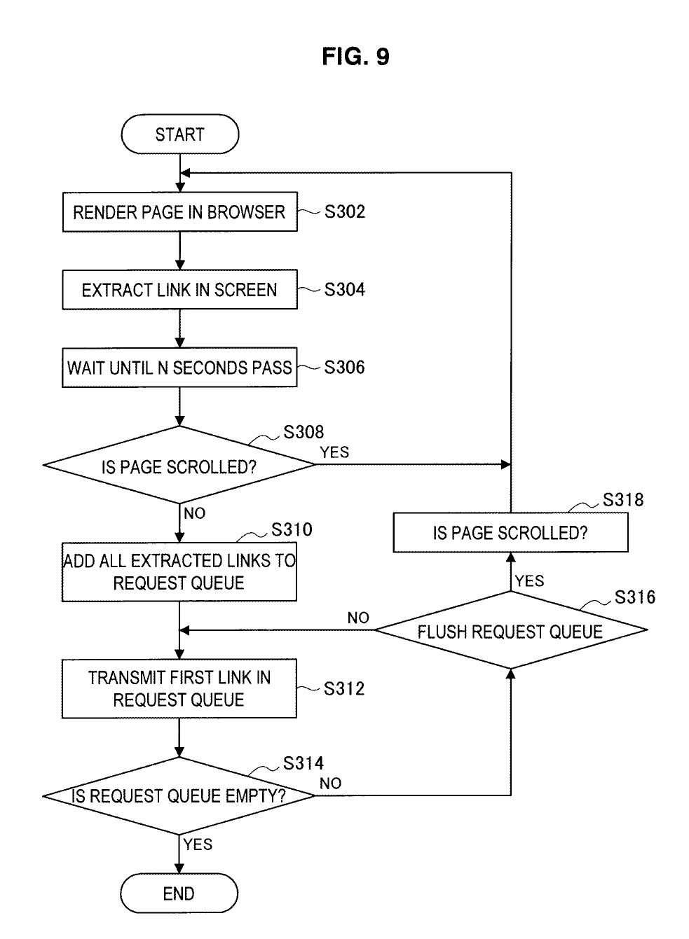

In the foregoing, the link extraction processing by the Web browser 10 has been described. Next, details of addition processing of a link to the request queue by the Web browser 10 will be described with reference to FIG. 9. While it is assumed in FIG. 8 that extracted links are all added to the request queue, if the user scrolls the screen immediately, there is the possibility that links that are less likely to be clicked will also be added to the request queue. Thus, whether to add a link to the request queue is determined below based on whether the user has scrolled the screen.

FIG. 9 is a flowchart showing addition processing of a link to the request queue by the Web browser 10. As shown in FIG. 9, first a page is rendered in the browser (S302). Then, links inside the display screen of the page rendered in step S302 are extracted (S304). Next, wait for n seconds (n is any number of seconds equal to or greater than 1 such as 2 or 3 seconds) (S306). By waiting for n seconds in step S306, it is possible to confirm that there is no scrolling of the display screen.

Then, whether the page has been scrolled is determined (S308). If determined in step S308 that the page has not been scrolled, links extracted in step S304 are all added to the request queue (S310). If determined in step S308 that the page has been scrolled, the processing returns to step S302.

Then, after links are added to the request queue in step S310, requests corresponding to links are transmitted to the Web server 20 in the order in which links are stored in the request queue (S312). In step S312, links will be transmitted to the Web server 20 one by one starting with the first link in the request queue.

Then, whether the request queue is empty is determined (S314). If determined in step S314 that the request queue is not empty, whether the page has been scrolled is determined again (S316). If the page has not been scrolled, links remaining the request queue are transmitted to the Web server 20 one by one.

On the other hand, if determined that the page has been scrolled in step S316, links stored in the request queue are flushed (deleted) (S318). After links in the request queue are flushed in step S318, the processing in step S302 is repeated again.

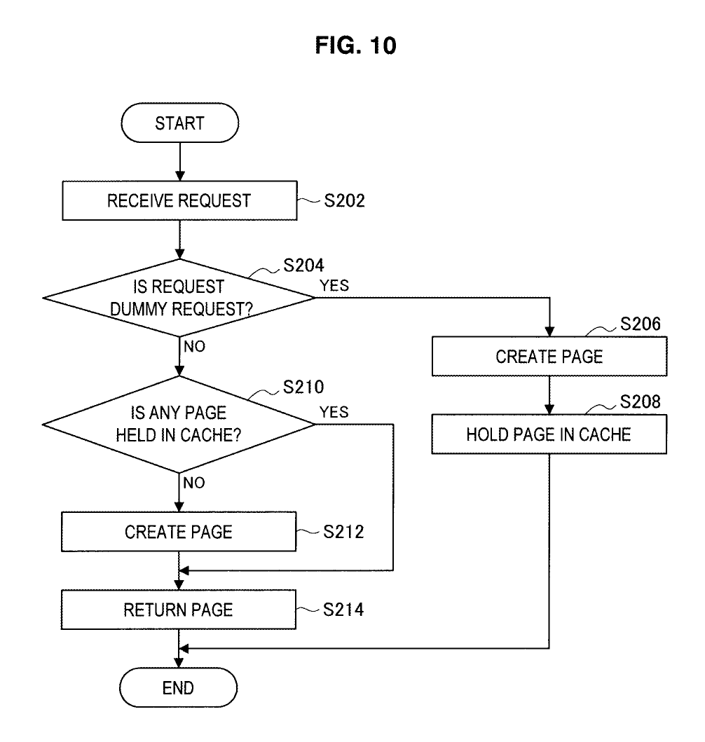

In the foregoing, the addition processing of a link to the request queue by the Web browser 10 has been described. Next, details of the operation of the Web server that has received a request message will be described with reference to FIG. 10. FIG. 10 is a flowchart showing processing of the Web server that has received a request message. As shown in FIG. 10, first the Web server receives a request transmitted from the Web browser 10 (S202). Then, the Web server determines whether the request received in step S202 is a dummy request (S204).

If determined in step S204 that the request is not a dummy request, the Web server determines whether a page corresponding to the request is held in the cache 212 (S210). If determined in step S210 that the corresponding page is held, the Web server performs processing in step S214. On the other hand, if determined in step S210 that the corresponding page is not held, the Web server creates a page corresponding to the request (S212). Then, the Web server returns the page created in step S212 or the page held in the cache 212 to the Web browser (S214).

If determined in step S204 that the request is a dummy request, the Web server creates a page corresponding to the dummy request (S206). Then, the Web server holds the page created in step S206 in the cache 212 (S208). In step S208, instead of, as described above, holding the created page, only a result of a query issued to a database may be held in the cache 212.

In the foregoing, the processing of the Web server that has received a request message has been described. In the present embodiment, as described above, pages can efficiently be cached even if memory resources are limited by looking ahead not only to link destination pages not yet accessed by the user, but also to only link destination pages displayed in the display area of the Web browser 10. If, as described above, the screen of the Web browser 10 is immediately scrolled, link destination pages more likely to be accessed can be cached by extracting link destinations displayed in the display area after being scrolled. Moreover, even if link destinations were less likely to be accessed due to access restrictions to Web services, by extracting link destinations displayed in the display area, link destinations more likely to be accessed can efficiently be cached.

It should be understood by those skilled in the art that various modifications, combinations, sub-combinations and alterations may occur depending on design requirements and other factors insofar as they are within the scope of the appended claims or the equivalents thereof.

For example, each step of processing of the Web browser 10 or the Web server 20 herein need not necessarily be executed chronologically in the order described as a flowchart. That is, each step of processing of the Web browser 10 or the Web server 20, even if steps are different processing, may be executed in parallel.

It is possible to create a computer program causing hardware such as a CPU, ROM, and RAM contained in the Web browser 10 or the Web server 20 to function equivalently to each configuration of the Web browser 10 and the Web server 20 described above. Moreover, a recording medium in which the computer program is stored can be provided.

The present application contains subject matter related to that disclosed in Japanese Priority Patent Application JP 2009-264116 filed in the Japan Patent Office on Nov. 19, 2009, the entire content of which is hereby incorporated by reference.

What is claimed is:

1. A Web server comprising:
a reception unit that receives a request to acquire content of a link destination displayed in a display area from among one or two or more link destinations contained in a page displayed in a Web browser connected via a network;
a content creation unit that creates content in accordance with the request received by the reception unit; and
a cache unit that caches the content created by the content creation unit in a storage apparatus.

2. The Web server according to claim 1, further comprising:
a determination unit that determines whether the request received by the reception unit is a dummy request to acquire content of a link destination not yet accessed,
wherein when the determination unit determines that the request is a dummy request, the content creation unit creates content in accordance with the dummy request.

3. The Web server according to claim 2,
wherein when a command indicating the dummy request is attached to the request, the determination unit determines that the request is the dummy request.

4. The Web server according to claim 1,
wherein the cache unit deletes, of the content cached in the storage apparatus, the content in accordance with a parent-child relationship with link destinations of the content displayed in the Web browser.

5. The Web server according to claim 1, further comprising:
a transmission unit that transmits, when the content corresponding to the request is cached in the storage apparatus by the cache unit, the cached content to the Web browser.

6. The Web server according to claim 2,
wherein when the determination unit determines that the request is not the dummy request, the content creation unit transmits the created content to the Web browser via the transmission unit.

7. The Web server according to claim 2,
wherein when the determination unit determines that the request is not the dummy request, the content creation unit transmits the content corresponding to the request and cached in the storage apparatus to the Web browser via the transmission unit.

8. A Web browser comprising:
an extraction unit that extracts a link destination displayed in a display area from among one or two or more link destinations contained in a page displayed in a display screen;
a request creation unit that creates a request to acquire content of the link destination extracted by the extraction unit; and
a transmission unit that transmits the request to a Web server via a network.

9. The Web browser according to claim 8,
wherein the request creation unit attaches a command indicating a dummy request to acquire content of a link destination not yet accessed to the request.

10. The Web browser according to claim 8,
wherein the extraction unit determines whether the link destination displayed in a display area is static content or dynamic content and extracts the link destination when the link destination is the dynamic content.

11. The Web browser according to claim 9,
wherein content created by the Web server in accordance with the dummy request is cached in a storage apparatus.

12. The Web browser according to claim 8,
wherein the request creation unit creates the request to acquire the content of the accessed link destination, further comprising:
a reception unit that receives the content in accordance with the request from the Web server.

13. The Web browser according to claim 12,
wherein the request creation unit creates the request to acquire the content of the accessed link destination, and
when the content in accordance with the request is cached in the storage apparatus, the reception unit receives the content cached in the storage apparatus.

14. A Web system comprising a Web browser connected to a Web server via a network,
the Web browser including:
an extraction unit that extracts a link destination displayed in a display area from among one or two or more link destinations contained in a page displayed in a display screen;
a request creation unit that creates a request to acquire content of the link destination extracted by the extraction unit; and
a transmission unit that transmits the request to the Web server,
the Web server including:
a reception unit that receives the request transmitted from the Web browser;
a content creation unit that creates content in accordance with the request received by the reception unit; and
a cache unit that caches the content created by the content creation unit in a storage apparatus.

15. A program causing a computer to function as a Web server, the Web server comprising:
a reception unit that receives a request to acquire content of a link destination among one or two or more link destinations displayed in a display area of a Web browser connected via a network;
a content creation unit that creates content corresponding to the request received by the reception unit; and
a cache unit that caches the content created by the content creation unit in a storage apparatus.

16. A program causing a computer to function as a Web browser, the Web browser comprising:
an extraction unit that extracts a link destination displayed in a display area from among one or two or more link destinations contained in a page displayed in a display screen;
a request creation unit that creates a request to acquire content of the link destination extracted by the extraction unit; and
a transmission unit that transmits the request to a Web server connected via a network.
